(19) United States
(12) Patent Application Publication
(10) Pub. No.: US 2020/0149955 A1
(43) Pub. Date: May 14, 2020

(54) RAISED PAVEMENT MARKER DETECTOR

(71) Applicant: Vincent Puruczky, Garrettsville, OH (US)

(72) Inventor: Vincent Puruczky, Garrettsville, OH (US)

(21) Appl. No.: 16/185,164

(22) Filed: Nov. 9, 2018

(51) Int. Cl. G01J 1/02; E01C 23/22; E01C 23/01; G01J 1/42

(52) U.S. Cl. CPC G01J 1/0271; G01J 1/4228; E01C 23/01; E01C 23/222

(57) ABSTRACT

A raised pavement marker detector on a paint truck to detect the interruption of line striping for raised pavement markers, including a housing attached by a bracket to a carriage of the truck. The housing includes a rear shaped body having a first plurality of openings extending therethrough. Each of the first plurality of openings contains a retro reflector sensor and each sensor has a housing containing a transmitter and a receiver. A rear cover closes the first plurality of openings through the rear shaped body to protect the sensors. A front body contains a second plurality of openings extending therethrough and mounted to the rear shaped body whereby the second plurality of openings extending through the front body overlaps the first plurality of openings through the rear rectangular shaped body so as to receive a lens portion of each retro reflector sensor within the first plurality of openings.

### FIELD OF INVENTION

The present invention relates generally to a detector to sense raised pavement markings

### BACKGROUND OF INVENTION

There are different types of marking materials used on roadways to direct traffic flow. To be visible to drivers during the night, retro-reflective materials are used. A retro-reflector is a device or surface that reflects light back to its source with a minimum of scattering.

There are two (2) types of retroreflective materials used on roadways. There are the spherical glass beads incorporated with the paint marking application and there are the reflective prisms used in road signs and also in raised pavement markings. This invention is concerned with the raised pavement markings.

There are many different styles of raised pavement markings (RPM's). There are those that are installed directly onto the pavement with an epoxy and others are recessed into the pavement either independent or encased within a casting currently made of cast iron. Such castings are utilized for snow plow areas to prevent the plows from removing the RPM.

The RPM's are placed in several different locations on the roadway depending on purpose. Certain retroreflective RPM's are placed near the painted pavement markings to supplement the markings and especially those installed near the centerline. RPM's are installed on the roadway after the line striping has been performed on newly constructed roadways. During maintenance striping or line striping, paint is applied directly over previously painted lines in order to improve visibility. During this procedure, RPM's may be encounter that are situated directly within the center lines and if painted over will lose their reflectivity properties. States have specific specifications that require, during the repainting process, that the line marking must be interrupted at each raised pavement marker to assure that the reflective lens is not painted over. For example, the state of Ohio requires a maximum gap of 18 inches at each marker and if they are painted over, they need to be replaced.

Currently, it is known to use a device that detects the metal casting of the recessed, snow plowable, raised pavement markers. When the metal casting is detected, the paint guns are shut off for a predetermined distance that is inputted by the operator. This method has proved faulty as other metal remnants within the road construction or garbage on top of the road surface can trigger the guns to be shut off at inappropriate times. This type of detector is positioned very close to the road which puts it at risk for being damaged from cracks or potholes in the pavement. In addition, this method is unusable in areas where the RPMs are not encased in the metal casting.

Another known method to interrupt the line striping when approaching a raised pavement marker is to have the operator manually shut the paint guns off using a toggle on/off switch. This method is ineffective because of human error in judging exactly when to switch off the guns as the RPM approaches the raised pavement marker and when to turn the guns back on so as to not avoid a larger gap than required by the state specifications. This method can also ineffective due to human error caused because the constant toggling of the guns between the on/off condition can also be monotonous in areas where the RPMs are more frequent.

### SUMMARY OF THE INVENTION

According to an embodiment of the present invention, there is disclosed a raised pavement marker detector on a paint truck to detect the interruption of line striping for raised pavement markers. The raised pavement marker detector includes a housing attached by a bracket to a carriage of the paint truck. The housing includes a rear shaped body having a first plurality of openings extending therethrough. Each of the first plurality of openings contains a retro reflector sensor and each of the retro reflector sensors has a housing containing a transmitter and a receiver. A rear cover closes the first plurality of openings through the rear shaped body to protect the retro reflector sensors. A front body contains a second plurality of openings extending therethrough and mounted to the rear shaped body whereby the second plurality of openings extending through the front body overlaps the first plurality of openings through the rear rectangular shaped body so as to receive a lens portion of each retro reflector sensor within the first plurality of openings.

Also according to an embodiment of the present invention, there is disclosed a paint truck incorporating road striping equipment. The paint truck incorporating road striping equipment includes a raised pavement marker detector disposed on the paint truck, and a matrix of one or more striping guns. Finally, a striping control system including a distance measuring device, having one or more control boxes, housing counters, input connections, and a programmable logic controller for controlling the matrix of one or more striping guns, in response to a signal generated by the raised pavement marker detector.

Further according to an embodiment of the present invention, there is disclosed a paint truck incorporating road striping equipment. The paint truck incorporating road striping equipment includes a raised pavement marker detector disposed on the paint truck to detect the interruption of line striping for raised pavement markers. The raised pavement marker detector is formed of a housing attached by a bracket to a carriage of the paint truck. The housing includes a rear shaped body having a first plurality of openings extending therethrough. Each of the first plurality of openings containing a retro reflector sensor and each of the retro reflector sensors having a housing containing a transmitter and a receiver. A rear cover closes the first plurality of openings through the rear shaped body to protect the retro reflector sensors. A front body contains a second plurality of openings extending therethrough and mounted to the rear shaped body whereby the second plurality of openings extending through the front body overlaps the first plurality of openings through the rear rectangular shaped body so as to receive a lens portion of each retro reflector sensor within the first plurality of openings. A matrix of one or more striping gunsis also included. Finally, a striping control system includes a distance measuring device, having one or more control boxes, housing counters, input connections, and a programmable logic controller for controlling the matrix of one or more striping guns, in response to a signal generated by the raised pavement marker detector.

### BRIEF DESCRIPTION OF THE DRAWINGS

The structure, operation, and advantages of the present invention will become further apparent upon consideration of the following description taken in conjunction with the accompanying figures (Figures). The figures are intended to be illustrative, not limiting.

Certain elements in some of the figures may be omitted, or illustrated not-to-scale, for illustrative clarity. The cross-sectional views may be in the form of slices, or near-sighted cross-sectional views, omitting certain background lines which would otherwise be visible in a true cross-sectional view, for illustrative clarity.

Often, similar elements may be referred to by similar numbers in various figures (Figures) of the drawing, in which case typically the last two significant digits may be the same, the most significant digit being the number of the drawing figure (Figure).

FIG. 1 is a side view of a truck incorporating road striping equipment, according to the present invention.

FIG. 2 is a three-dimensional view of the marker detector used with the road striping equipment, according to the present invention.

FIG. 3 is a three-dimensional view of the marker detector housing used with the road striping equipment, according to the present invention.

FIG. 4 is a three-dimensional, exploded side view of the marker detector used with the road striping equipment, according to the present invention.

FIG. 5 is a schematic view of a circuit board connecting the sensors in the marker detector to a programmable logic controller which in turn is connected to a switchbox, according to the present invention.

FIG. 6 is an illustration showing the paint and glass guns of the road striping for applying the paint and glass beads to a road surface on an operator's computer screen that allows an operator to adjust the gap and sensor distance for determining when the paint and glass guns are turned on and off.

### DETAILED DESCRIPTION OF THE PREFERRED EMBODIMENT

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.)

In the drawings accompanying the description that follows, often both reference numerals and legends (labels, text descriptions) will be used to identify elements. If legends are provided, they are intended merely as an aid to the reader, and should not in any way be interpreted as limiting.

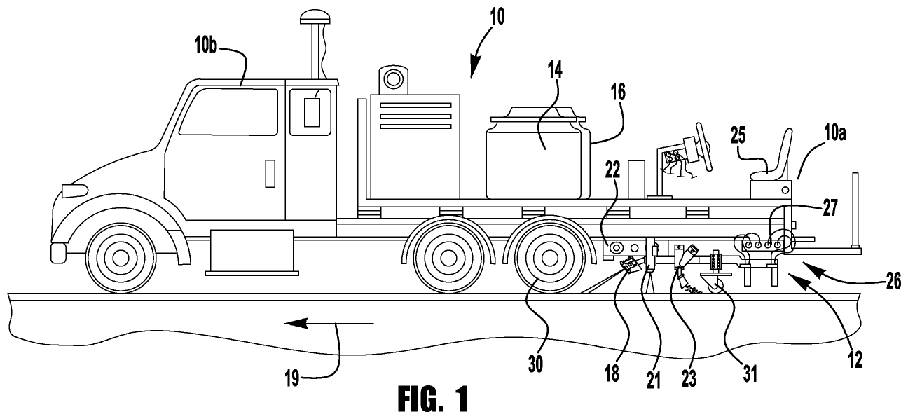

Referring to FIG. 1, there is illustrated a side view of a truck 10 incorporating road striping equipment 12. The striping equipment 12 typically includes both a paint tank 14 and a glass bead tank 16 (behind tank 14) for supplying striping material, paint and glass beads, respectively, to one or more striping guns 18. The striping guns 18 are preferably mounted on a carriage 22. Striping guns 18 can be one or more paint guns 21 and/or one or more glass bead dispensing guns 23. The truck 10 includes a single carriage 22 disposed as a rear carriage, positioned near the rear portion 10a of the truck 10.

In general terms, the carriage 22 can support a matrix of one or more striping guns 18. Each matrix consists of one or more gun lines arranged across the width of the truck 10 and perpendicular to the direction of the striping equipment truck's travel as indicated by arrow 19. Each gun line consists of a row of guns 21 and 23 in the direction of and parallel to direction of travel of the truck 10. Typically, the paint guns 21 are arranged in front of the glass guns 23 so that glass beads dispensed from the glass guns are dispensed onto freshly painted portions of the roadway. The dispensing of glass beads by the glass guns 23 is also delayed by a predetermined amount dependent on the distance between the paint and glass guns 21 and 23. The delay ensures that the dispensing of the glass beads matches the dispensing of paint so that glass beads are dispensed onto freshly painted portions of the roadway and not the unpainted portions of the roadway.

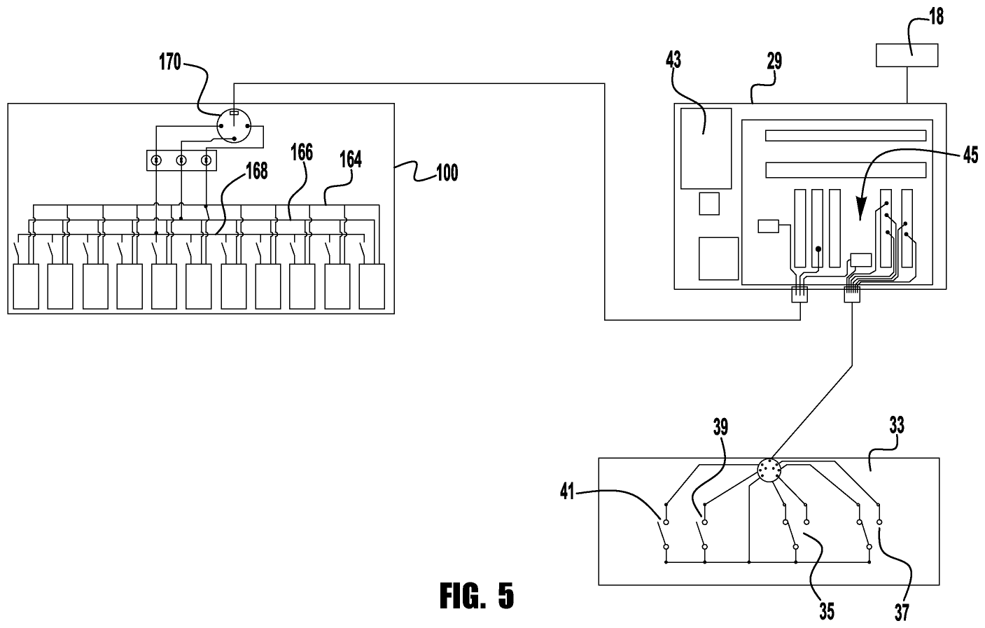

An operator, typically sitting in chair 25, sets the delay, usually in terms of distance, using a programmable logic controller 27, as shown in FIG. 5 and discussed hereinafter. Therefore, the glass guns 23 are activated only after the truck 10 has travelled an operator-programmed distance after the activation of the paint guns 21. Glass beads applied to painted portions reflect light and make the painted portions more visible. The application of glass beads, as with the present embodiment, is optional.

Typically, either thermoplastic or paint are used to stripe roadways. Throughout the specification and the claims, the use of the word “paint” should be construed to cover both thermoplastic, paint, and any other material used to apply to a roadway. The use of the terminology “striping material” will refer to thermoplastic, paint, glass beads, and any other material used to apply to a roadway. Furthermore, the use of the terminology “painting” and “striping” are interchangeable, and “striping guns” refers to both paint guns and glass guns. Typically, roads are striped using white and/or yellow paint. Occasionally, black paint is also used. Each gun 18 in a gun line dispenses either paint of a certain color or glass beads. Depending on the requirements of the painting operation, only certain ones of the guns 18 in a gun line are activated.

A striping control system 26 includes a distance measuring device, typically including one or more control boxes 27, housing counters 43, input connections 45, and a programmable logic controller 29 for controlling the matrix of one or more striping guns 18. As illustrated, striping control system 26 includes the distance measuring device, such as a pulse generator (not shown). The pulse generator generates pulses in relation to the rotation of a wheel 30 of the truck 10, a fifth (extra) wheel 31, the transmission, and any other device, and outputs pulse signals representing the distance traveled.

The striping control system 26 outputs control signals for controlling the matrix of one or more striping guns 18. Specifically, the control signals turn on or turn off the paint and/or glass guns 18. Typically the turning on or off of the paint and/or glass guns 18 is performed by energizing or de-energizing a solenoid. The one or more control boxes 27 includes an operator switch box 33 including a delay switch 35, a gap switch 37, an auto/manual switch 39, and an on/off switch 41.

When the auto/manual switch 39 is in the auto setting mode and an operator places the delay switch 35 or gap switch 37 in the settings, the control box 27 outputs a control signal to a programmable logic controller 29 via input connections 45. The programmable logic controller 29 then sends control signals to the paint and glass guns 21 and 23, respectively, corresponding to the selected switches from the operator switch box 33, to paint a cycle stored in the programmable logic controller.

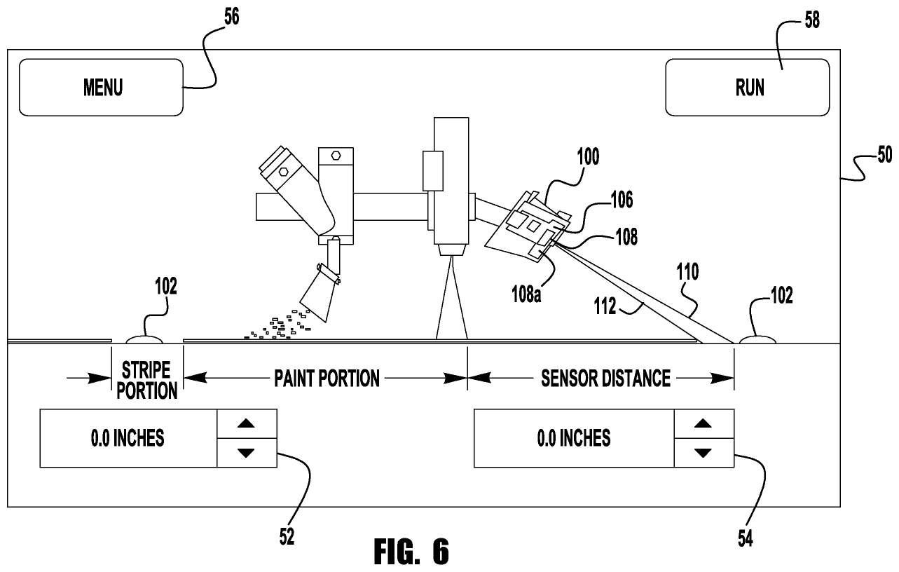

As shown in FIG. 6, each cycle stored in programmable logic controller 29 has a paint portion and a skip portion. The paint portion is the distance over which paint is applied, and the skip portion is the distance over Which no paint is applied. The cycle length is the length of one paint portion and associated skip portion which will be repeated as a cycle. The term “skipline” refers to the continuous and consecutive repetition of a cycle. All the cycles, blank lines, or solid lines being painted by a matrix of striping guns is referred to as a painting or striping pattern.

The control box 27 may also include a paint switch (not shown). By operating the paint switch, an operator can change the color of paint supplied to the matrix of one or more striping guns 18.

The counter box 27 includes counters 43 for measuring the footage of paint and glass used. The counter box 27 can be disposed in the cab 10b of the truck 10 and/or in the rear portion 10a of the truck. The counters 43 measure the footage (distance) of paint and glass used based on the output signals from the one or more control boxes 27, the programmable logic controller 29, and the distance measuring device 26. The counter 43, one counter per gun 18, can count the footage of paint and glass applied by each gun based on the distance each gun applied paint or glass during the striping operation.

Except for the control signals produced by the control box 27 when in the solid setting or off setting, programmable logic controller 29 receives all control signals produced by the control box 27, and distance measuring device 26. The programmable logic controller 29 includes a control panel 50 with control keys 52 and 54. By operating an appropriate control key 52 or 54, an operator can view on display the vehicle speed, the time of day, the cycle length of the stored cycle, the length of the paint portion of the stored cycle and the distance travelled in feet. The programmable logic controller 29 may include a reset control key (not shown) which allows an operator to reset accumulated values such as the distance travelled in feet.

The control panel 50 also includes a menu key 56, a gap control key 52, and a run key 58. The menu key 56 is used to calibrate distance measurement using distance measuring device 26. After depressing the menu key 56 by the operator, the truck 10 is driven a fixed distance and the operator again depresses the menu key. The programmable logic controller 29 counts the number of pulses received from distance measuring device 26 while travelling the fixed distance. The programmable logic controller 29 can now compute the distance travelled based on the pulses received over the fixed distance.

The gap control key 52 allow an operator to set the delay, in units of distance, from the point at which a paint gun 21 turns on until a corresponding glass gun 23 turns on. The menu key 56 sets programmable logic controller 29 in a programming mode. In the programming mode, an operator can enter a cycle. Programming a cycle consists of inputting, in units of distance, the paint portion and skip portion of the cycle. The conventional programmable logic controllers can only store a single cycle. Therefore, to paint a different skipline, an operator must stop the painting operation and reprogram the cycle. To paint different skiplines using the matrix of one or more striping guns 18 at the same time requires the use of two programmable logic controllers 29. Each programmable logic controller 29 would have control over each individual matrix of one or more striping guns 18.

The raised pavement marker detector 100 is designed to detect the interruption of line striping for raised pavement markers (RPM) 102 through the detection of prismatic or cube corner retro reflectivity. Because the marker detector 100 reacts to the retro reflectivity of the RPM 102, this allows it to detect all RPM's that exhibit retro reflectivity and not just the ones encased in the metal casting. The marker detector 100 is elevated higher off the ground so road conditions will not damage the unit during operation. The marker detector 100 is integrated into the programmable logic controller 29. Once parameters are set by the operator, it will automatically compensate for variable speeds.

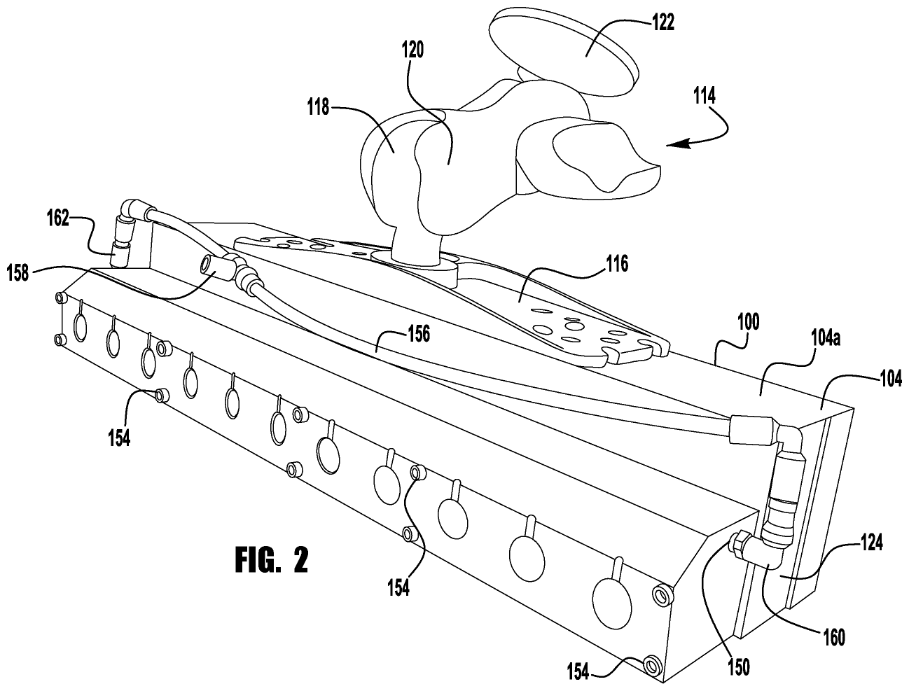

FIGS. 2, 3 and 4 illustrate the marker detector 100 consisting of a housing 104 attached in front of the paint and bead guns 21 and 23 on the carriage 22 and contains a plurality of retro reflector sensors 106, such as for example an OPG281 Retro-reflective sensor. Any appropriate number of retro reflector sensors 106 may be utilized, such as eleven sensors. As the marker detector 100 moves horizontally along the road, a red light 110 is emitted from each of the eleven sensors 106.

As illustrated in FIG. 6, when a RPM 102 is approached, the light beam 112 is reflected back to the receiver side 108a of the lens 108 in each sensor 106. The sensor 106 then sends an output signal notifying the programmable logic controller 29 of the reflective detection. The programmable logic controller 29 will regulate the paint cycle stored in the controller for coordinating the on/off times for cyclic paintings. The programmable logic controller 29 will then shut of the paint guns 18 for the time/distance interval that has been predetermined by the program.

The program within the programmable logic controller 29 has parameters that are controlled by the operator. The two required parameters that need to be set by the operator are the gap, as set by the gap key 52, and sensor distance, as set by the gap key 54. The gap interval is the length, typically measured in inches, that the guns 18 need to be shut off to avoid painting the RPM 102. The sensor distance is the distance from the paint gun 18 to the point at which the sensor light beam 110 will make contact with the RPM 102, and is typically measured in inches. The sensor distance is factored with the speed of the truck 10 to calculate the reaction time or point at which to shut the guns 18 off for a determined gap. If during operation the operator realizes that the gap is too long or too short, he/she has the ability to adjust or fine tune both the gap and sensor light beam distance from the switch box 33 mounted near the paint guns 18.

Since this system utilizes fully programmable microprocessors and microprogrammable logic controllers for both the Human Machine Interface (HMI) and the switch box programmable logic controllers, many other customizations and adaptations can be easily made to this system (for instance adding sensors which can detect the metal castings or solar powered pavement markers).

As illustrated in FIG. 2, the marker detector 100 consists of a housing 104. The housing 104 is mounted to the carriage 22 with a bracket 114. The bracket 114 is formed with a first plate 116 that is connected to the top or upper portion 104a of the housing 104. The first plate 116 is connected to a ball mount 118, which is adjustably secured to a socket 120. In turn, the socket 120 is attached to a second plate 122, which in turn is connected to the carriage 22. The bracket 114 allows the housing 104 to be adjustable, in a range of directions.

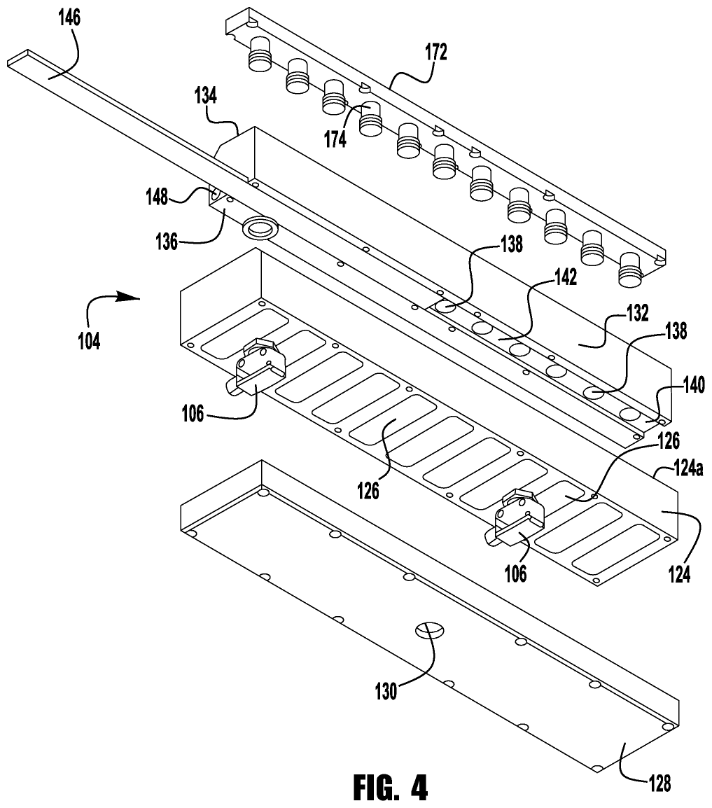

As illustrated in FIG. 4, the housing 104 includes a rear rectangular shaped body 124 having a plurality of openings 126 extending therethrough. The openings 126 receive the portion of the housing of the retro reflector sensors 106 containing the transmitter, typically an emitting laser and a receiver, typically a sensor light beam. The rear rectangular shaped body 124 is hollow to receive the housings of the retro reflector sensors 106. A rear cover 128 closes the plurality of openings 126 of the rear rectangular shaped body 124, and protects the retro reflector sensors 106 and wiring for directing the output of the sensors to the notifying the programmable logic programmable logic controller 29 of the reflective detection. The rear cover 128 includes an opening 130 to allow the wiring (not shown) from the sensors 106 to be passed therethrough.

The housing 104 further includes a front body 132 which is mounted to the top surface 124a of the rear rectangular shaped body 124 and overlays plurality of openings 126 extending therethrough. The front body 132 has first and second opposite surfaces 134 and 136, generally parallel to each other. The front body 134 has a plurality of openings 138 extending through the first and second opposite surfaces 134 and 136, which overlap the plurality of openings 126 of the body 124, and receive the lens portion of each sensor 106.

A groove 140 is formed within the second opposite surface 136 and extends the length therein, such that the plurality of openings 138 are open to the bottom surface 142 of the groove 140. Each of the plurality of openings 138 contains a slot 144 which is formed within the first surfaces 134, and intersects each of the plurality of openings. A transparent strip of material 146, preferably plastic, is designed to be received within the groove, and held therein by the mating of the front body 132 and the rear rectangular shaped body 124. The strip of material 146 covers the plurality of openings 138 formed within the groove 140, as well as openings 126 extending through the rear rectangular shaped body 124 so that debris from the road, which enters the openings will not damage the sensors 106 contained therein.

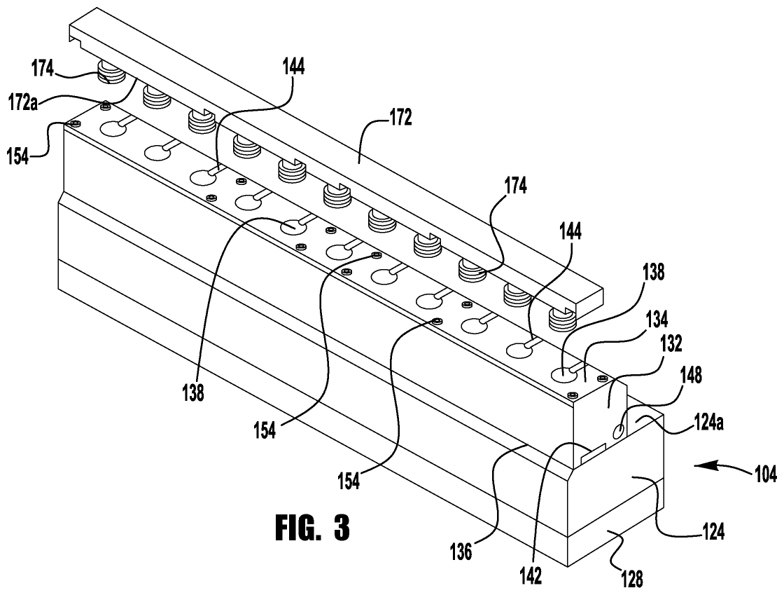

As seen in FIG. 3, a passageway 148 extends through the length of the front body 132, and has a first and second compressed air inlets 150 and 152 respectively, formed at either end of the passageway. A plurality of escape ports 154 are formed between the passageway 148 and the first and second compressed air inlets 150 and 152. A hose 156 has an inlet port 158 disposed in the middle of the hose, and two outlet ports 160 and 162 at either end of the hose, and connected to the first and second compressed air inlets 150 and 152.

All of the reflective sensors 106 are wired in parallel circuit via line 164, such as a +24vdc, via line 166, such as a Ground, and via line 168, such as a 24vdc sensor output. These wires are all tied to a 3 wire shielded M12 process connector 170. If any one of the sensors 106 pickup reflectively from an RPM 102, this would result in a sense output that is sent to the programmable logic controller 29.

When the RPM board detects a RPM 102, a +24vdc pulse is sent to an input pin of the programmable logic controller 29. The program written in the programmable logic controller 29 then tells the gun control outputs to turn the paint guns 18 off, as well as the duration of time to keep them off. These parameters can be set by either the operator in the cab 10b of the truck 10 as well as the control box operator in the operator's station on the back of the paint truck.

The simple operator's switchbox makes for quick and easy fine tuning adjustments by toggling the Delay and GAP switches. Each switch movement will increase or decrease the amount of GAP or Delay by 1/10 of a foot. There is also an ON/OFF switch to disable all operations of the RPM detector. This switchbox is connected to the programmable logic controller by a single CAT6 shielded cable and the entire

A storage protection cover 172 extends the length of the surface 134 of the front body 132 and includes a plurality of plugs 174 extending outward from the bottom surface 172a of the protection cover 172. The plugs 174 are spaced from each other to match up with the spacing between the plurality of openings 138 so that the protection cover can be mounted to the front body with each of the openings 138 plugged with a plug 174. Each of the plugs 174 has an o-ring mounted to the free end so that the plugs will fit snugly in the openings 138 and not easily fall out. When the marker detector 100 is not being used, the storage protection cover 172 is secured onto the front body 132 to protect the sensors 106 from dirt and debris which is thrown up from the road as the truck travels between locations.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

The invention consists of a unit attached in front of the paint and bead guns on the carriage and contains 11 retro reflector sensors. As the Highway Striper moves horizontally along the road, a red light is emitted from each of the 11 sensors. When a prismatic reflector is approached the light beam is reflected back to the receiver side of the lens in the sensor. The sensor then sends an output signal notifying the PLC of the reflective detection. The PLC will then signal the timing system (which is the automated counting system for coordinating the speed/distance of the truck with appropriate on/off times for cyclic paintings). The timing system will then shut of the paint guns for the time/distance interval that has been predetermined by the PLC program. The PLC program has parameters that are controlled by the operator. There are two required parameters that need to be set by the operator, the gap and sensor light beam distance. The gap interval is the length measured in inches that the guns need to be shut off to avoid painting the reflector. The sensor light beam distance is the distance from the paint gun to the point at which the sensor light beam will make contact with the RPM reflector, and is also measured in inches. The sensor light beam distance is factored with the speed of the truck to calculate the reaction time or point at which to shut the guns off for determined gap. If during operation the operator sees that the gap is too long or too short, he/she has the ability to adjust or fine tune both the gap and laser distance from the switch box mounted near the painter.

Since this system utilizes fully programmable microprocessors and microprogrammable logic controllers for both the Human Machine Interface (HMI) and switch box programmable logic controllers, many other customizations and adaptations can be easily made to this system (for instance adding sensors which can detect the metal castings or solar powered pavement markers).

1. A raised pavement marker detector on a paint truck to detect the interruption of line striping for raised pavement markers, comprising;
a housing attached by a bracket to a carriage of the paint truck;
the housing including a rear shaped body having a first plurality of openings extending therethrough;
each of the first plurality of openings containing a retro reflector sensor and each of the retro reflector sensors having a housing containing a transmitter and a receiver;
a rear cover closing the first plurality of openings through the rear shaped body to protect the retro reflector sensors; and
a front body containing a second plurality of openings extending therethrough and mounted to the rear shaped body whereby the second plurality of openings extending through the front body overlaps the first plurality of openings through the rear rectangular shaped body so as to receive a lens portion of each retro reflector sensor within the first plurality of openings.

2. The raised pavement marker detector of claim 1, further including the bracket formed with a first plate that is connected to an upper portion of the housing.

3. The raised pavement marker detector of claim 2, wherein the first plate is connected to a ball mount, which is adjustably secured to a socket, and wherein the socket is attached to a second plate connected to the carriage.

4. The raised pavement marker detector of claim 3, further including the rear rectangular shaped body being hollow to receive the housings of each of the retro reflector sensors.

5. The raised pavement marker detector of claim 4, further including the front body having first and second surfaces disposed opposite from each other and generally parallel to each other.

6. The raised pavement marker detector of claim 5, wherein a groove is formed within the second opposite surface of the front body and extends the length thereof, such that the second plurality of openings are open to a bottom surface of the groove.

7. The raised pavement marker detector of claim 6, wherein each of the second plurality of openings of the front body contains a slot which is formed within the first surface, and intersects each of the second plurality of openings.

8. The raised pavement marker detector of claim 7, wherein a transparent strip of material is received within the groove, and held therein by the mating of the front body and the rear rectangular shaped body to each other, whereby the transparent strip of material covers the second plurality of openings intersecting the groove, as well as the first plurality of openings extending through the rear rectangular shaped body.

9. The raised pavement marker detector of claim 8, further including a passageway extending through the length of the front body, and having first and second compressed air inlets formed at either end of the passageway.

10. The raised pavement marker detector of claim 9, wherein a plurality of escape ports are formed between the passageway and the first and second compressed air inlets.

11. The raised pavement marker detector of claim 10, further including a hose having an inlet port disposed in the middle of the hose, and two outlet ports at either end of the hose, the two outlet ports being connected to the first and second compressed air inlets.

12. A paint truck incorporating road striping equipment, comprising;
a raised pavement marker detector disposed on the paint truck;
a matrix of one or more striping guns; and
a striping control system including a distance measuring device, having one or more control boxes, housing counters, input connections, and a programmable logic controller for controlling the matrix of one or more striping guns, in response to a signal generated by the raised pavement marker detector.

13. The paint truck incorporating road striping equipment of claim 12 wherein the raised pavement marker detector consists of a housing attached in front of the matrix of one or more striping guns and containing a plurality of retro reflector sensors for detecting raised pavement markers.

14. The paint truck incorporating road striping equipment of claim 13 wherein the raised pavement marker detector is integrated into the programmable logic controller to detect and signal a presence of raised pavement markers.

15. The paint truck incorporating road striping equipment of claim 14 wherein the plurality of retro reflector sensors is in communication with the programmable logic controller to regulate a paint cycle stored in the programmable logic controller.

16. A paint truck incorporating road striping equipment, comprising;
a raised pavement marker detector disposed on the paint truck to detect the interruption of line striping for raised pavement markers;
the raised pavement marker detector formed of a housing attached by a bracket to a carriage of the paint truck;
the housing including a rear shaped body having a first plurality of openings extending therethrough;
each of the first plurality of openings containing a retro reflector sensor and each of the retro reflector sensors having a housing containing a transmitter and a receiver;
a rear cover closing the first plurality of openings through the rear shaped body to protect the retro reflector sensors;
a front body containing a second plurality of openings extending therethrough and mounted to the rear shaped body whereby the second plurality of openings extending through the front body overlaps the first plurality of openings through the rear rectangular shaped body so as to receive a lens portion of each retro reflector sensor within the first plurality of openings;
a matrix of one or more striping guns; and
a striping control system including a distance measuring device, having one or more control boxes, housing counters, input connections, and a programmable logic controller for controlling the matrix of one or more striping guns, in response to a signal generated by the raised pavement marker detector.

17. The paint truck incorporating road striping equipment of claim 16 wherein the raised pavement marker detector consists of a housing attached in front of the matrix of one or more striping guns and containing a plurality of retro reflector sensors for detecting raised pavement markers.

18. The paint truck incorporating road striping equipment of claim 17 wherein the raised pavement marker detector is integrated into the programmable logic controller to detect and signal a presence of raised pavement markers.

19. The paint truck incorporating road striping equipment of claim 18 wherein the plurality of retro reflector sensors is in communication with the programmable logic controller to regulate a paint cycle stored in the programmable logic controller.

20. The paint truck incorporating road striping equipment of claim 19, further including:
a passageway extending through the length of the front body, and having first and second compressed air inlets formed at either end of the passageway;
a plurality of escape ports are formed between the passageway and the first and second compressed air inlets; and
a hose having an inlet port disposed in the middle of the hose, and two outlet ports at either end of the hose, the two outlet ports being connected to the first and second compressed air inlets.
